(19) United States
(12) Patent Application Publication
(10) Pub. No.: US 2021/0207809 A1
(43) Pub. Date: Jul. 8, 2021

(54) MODULAR OVEN FOR MULTIPLE USE

(71) Applicants: PLINIO LUIZ NOGUEIRA, SAO PAULO (BR); José Eduardo GAYOTTO, SAO PAULO (BR); Pedro Held ALMEIDA, SAO PAULO (BR)

(72) Inventors: PLINIO LUIZ NOGUEIRA, SAO PAULO (BR); José Eduardo GAYOTTO, SAO PAULO (BR); Pedro Held ALMEIDA, SAO PAULO (BR)

(21) Appl. No.: 17/055,731

(22) PCT Filed: May 9, 2019
(86) PCT No.: PCT/BR2019/050173

§ 371 Date: Nov. 16, 2020

(30) Foreign Application Priority Data
May 14, 2018 (BR) 10 2018 009734 2

(51) Int. Cl. F24B 1/195; F24B 1/188

(52) U.S. Cl. CPC F24B 1/195; F24B 1/1886

(57) ABSTRACT

A modular oven used as a pizza oven, a wood-burning stove, a barbecue PIT and an open fire. Equipment combining the functions of a wood-burning stove, a barbecue, a pizza oven and a space for an open fire in a single modular component, and allowing easy movement based on castors, is not known. The object of the present invention is to provide a modular oven formed by a vertical structure composed of modules that may be removed and installed, allowing the desired equipment to be constructed. A further object is to be able to provide the structure in the form of modular components made from refractory material, for example refractory concrete, which facilitates the construction thereof. A further object is to provide the base thereof as a heat source, with an opening designed to receive firewood and able to receive other modules or to act as an open fire.

The present invention patent deals with a modular oven that allows its use as a pizza oven, wood stove, barbecue and fire pit.

Equipment that combines the functions of a Rocket Wood Stove, Barbecue, Pizza Oven and Fireplace Space is not known in a single modular piece that allows easy mobility, supported on casters.

Only those that combine the functions of Barbecue and Pizza Oven are known in the market, or are produced in fixed bodies, which demand space and larger structures, which do not allow easy mobility and require installation.

The object of the present patent is to provide a modular multipurpose oven that is formed by a vertical structure composed of modules that can be removed and placed, which allows the desired equipment to be formed.

### OBJECTIVES OF THE INVENTION

Another objective is to be able to provide the structure in modular pieces in refractory material, for example refractory concrete, which facilitates its construction.

Another objective is to provide a structure provided with a base formed of wheels, which allows for easy displacement of the set.

Another objective is to provide its base as a heat source, with a nozzle designed to receive firewood and which can receive other modules, or act as a fire.

Another objective is to allow that when used as a barbecue, it can receive an intermediate module that receives coal.

Another objective is to internally include a metal conductor duct in an “L” shape for burning firewood, when the equipment is used as a wood stove or pizza oven, with such a tube removed for the barbecue and campfire functions.

### DESCRIPTION OF THE DRAWINGS

The attached drawings show views of the patent object as follows:

FIG. 1—Front view of the equipment.

FIG. 2.—Side view of the equipment.

FIG. 3.—Front view of a reduced equipment.

FIG. 4.—Shows an exploded view of the equipment that constitutes equipment.

FIG. 5.—Shows a view of the set acting as a wood stove.

FIG. 6.—Shows a view of the set acting as a barbecue.

FIG. 7.—Shows a view of the set acting as a pizza oven.

FIG. 8.—Shows a view of the set acting as a fire.

FIG. 9.—Shows a view of the assembly with the cover applied.

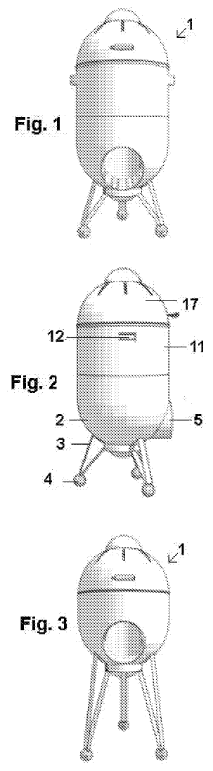

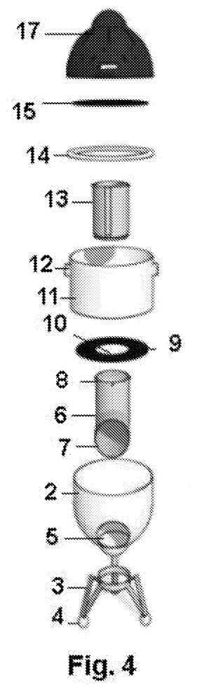

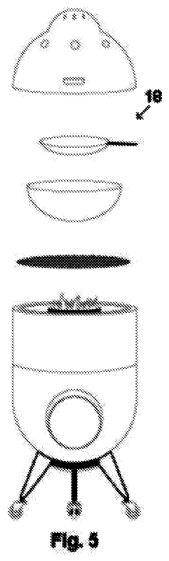

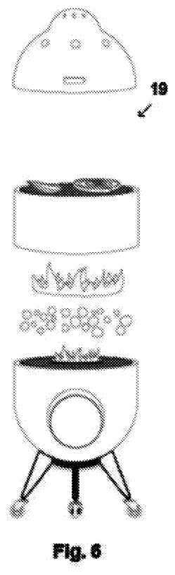

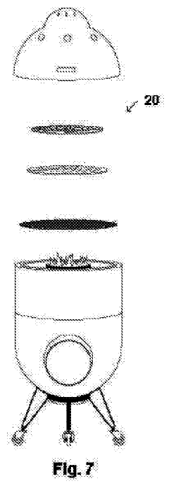

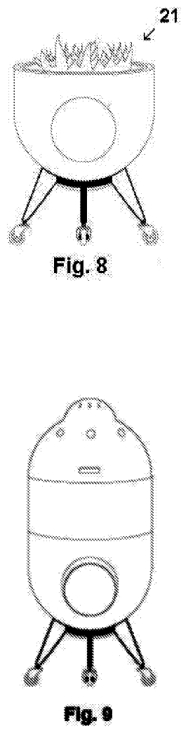

### DETAILED DESCRIPTION OF THE INVENTION

The equipment (1) is formed by a base with a semi-spherical bottom (2) with lower supports (3) for casters (4), the base (2) being provided with a nozzle (5) for wood entry, in this condition it is used as a fire.

An “L” tube (6) whose horizontal bottom (7) is fitted inside the nozzle (5) and whose upper section (8) of the tube receives a grid (9) with a central passage on its top (10) being that such a grid is supported on the upper edge of the base (2).

A circular ring (11) that can be equipped with handles (12) can be placed on the base (2), in this situation the equipment can be used as a barbecue and on the grill (10) and inside the ring (11) charcoal can be placed, in this condition of use as a barbecue the fire can be generated from wood placed on the base (1) and/or charcoal disposed inside the ring (11)

A complementary duct (13) can be placed inside the ring (11) and connected to the top (8) of the tube (6) in order to carry the heat, with a guide (14) maintaining the duct (13) in the vertical position, a second grid (15) can be placed on the top edge of the ring (11).

In this configuration, the “L” tube (6) and the complementary duct (13), which is already known in the literature as “rocket”, allow better fire targeting, saving the amount of wood burned.

This condition allows the equipment to act as a wood stove or as a pizza oven with the fire generated by the wood from the base (2) to be carried by the pipe (8) and by the connection (13) to the grill (15).

A cover (17) is placed on top of the set that allows the best functioning of the set in each of its functions, being able to be placed or removed according to the need, including the possibility of having a hinge to facilitate its opening.

This way the equipment can be used as a wood stove barbecue (19), wood oven (20) and fire pit (21).

1- MODULAR OVEN FOR MULTIPLE USE comprising
a base with lower supports (3) for casters (4),
the base (2) being provided with a nozzle (5) for firewood entry,
the base (2) having an internal L-shaped tube (6) whose horizontal bottom (7) fits inside the nozzle (5) and whose upper section (8) of the tube receives in its top a grid (9) with a central passage (10), being that this grid is supported on the upper edge of the base (2).

2- MODULAR OVEN FOR MULTIPLE USE, according to claim 1 characterized by the fact that a circular ring (11) is provided over (2).

3- MODULAR OVEN FOR MULTIPLE USE according to claim 1 characterized by the fact that a complementary duct (13) is provided inside the ring (11) and connected to the top (8) of the tube (6), a guide (14) is provided to keep the duct (13) in an upright position, receiving a second grid (15) on the top edge of the ring (11) at the top.

4- MODULAR OVEN FOR MULTIPLE USE according to claim 1 characterized by the fact that a cover (17) is provided arranged at the top of the set.

5- MODULAR OVEN FOR MULTIPLE USE according to claim 1 characterized by the fact that the base (2) has its lower semi-spherical region.

6- MODULAR OVEN FOR MULTIPLE USE, according to claim 1 characterized by the fact that the base (2) and the ring (11) are made of refractory concrete.

7- MODULAR OVEN FOR MULTIPLE USE, according to claim 1, characterized in that the base (2) and ring (11) are made of refractory metal.

8- MODULAR OVEN FOR MULTIPLE USE, according to claim I characterized in that the base (2) and ring (11) are pre-molded.
